(19) United States
(12) Patent Application Publication
(10) Pub. No.: US 2026/0092572 A1
(43) Pub. Date: Apr. 2, 2026

(54) FUEL CONSUMPTION OPTIMIZATION SYSTEM

(71) Applicant: Volvo Truck Corporation, Göteborg (SE)

(72) Inventors: Oscar Stjernberg, Göteborg (SE); Martin Wilhelmsson, Torslanda (SE); Roland Kvist, Braås (SE); Leo Laine, Göteborg (SE)

(21) Appl. No.: 19/336,990

(22) Filed: Sep. 23, 2025

(30) Foreign Application Priority Data
Oct. 1, 2024 (EP) 24204041.8

(51) Int. Cl. F02D 41/38

(52) U.S. Cl. CPC F02D 41/38; F02D 2200/0625; F02D 2200/1002

(57) ABSTRACT

A fuel consumption optimization system including a control unit configured to operate a power unit in a first measurement phase including activation of a first combustion chamber and deactivation of a second combustion chamber and a second measurement phase including deactivation of the first combustion chamber and activation of the second combustion chamber; a measurement unit configured to determine a first measurement corresponding to the first combustion chamber and a second measurement corresponding to the second combustion chamber; and wherein the control unit is configured to operate the power unit in an optimization phase including operation of one or more of the first combustion chamber in correlation with one or more of the first measurement and the second measurement and the second combustion chamber in correlation with one or more of the first measurement and the second measurement.

### PRIORITY APPLICATIONS

The present application claims priority to European Patent Application No. 24204041.8, filed on October 1, 2024, and entitled “FUEL CONSUMPTION OPTIMIZATION SYSTEM,” which is incorporated herein by reference in its entirety.

### TECHNICAL FIELD

The disclosure relates generally to vehicles. In particular aspects, the disclosure relates to a fuel consumption optimization system configured for use on a vehicle.

The disclosure may relate to heavy-duty vehicles, such as trucks, buses, and/or construction equipment, among other vehicle types. However, although the disclosure may be described with respect to a particular vehicle, the disclosure is not restricted to any particular vehicle.

### BACKGROUND

An engine of a vehicle, such as an internal combustion engine and/or hybrid internal combustion engine, typically includes an engine block defining one or more cylinder configured for reciprocation of a piston, which forms a combustion chamber. A fuel, such as a hydrogen-based fuel and/or a hydrocarbon-based fuel, is mixed with air and ignited in the combustion chamber. Pressure produced from combustion of the fuel mixed with air applies force on the piston, thereby converting chemical energy to mechanical energy.

Poor vehicle fuel efficiency of a vehicle, which corresponds to a ratio between distance traveled and fuel and/or energy consumed by the vehicle, may correspond to improper operation of the engine of the vehicle. Poor fuel efficiency of the vehicle results in a decreased range of travel of the vehicle, increased fuel and/or energy costs of the vehicle, increased pollution caused by the vehicle, and/or the like.

Currently available systems for improving fuel efficiency of a vehicle typically include incorporating new and/or modified structures into an engine of the vehicle, resulting in increased costs and/or complexity associated with the vehicle. Additionally or alternatively, currently available systems only employ metrics corresponding to the engine of the vehicle as a complete unit, resulting in imprecise, inaccurate, incomplete, and/or unbalanced metrics used for improvement of fuel efficiency of the vehicle.

It is desirable to provide a fuel consumption optimization system configured for use on a vehicle that is configured to determine an efficiency and/or performance of each combustion chamber of a plurality of combustion chambers included by an internal combustion engine and/or a hybrid internal combustion engine of the vehicle to precisely and dynamically improve fuel consumption of the vehicle, without complex implementation.

### SUMMARY

According to aspects of the disclosure, a fuel consumption optimization system configured for use on a vehicle is provided. The vehicle includes a power unit including at least a first combustion chamber and a second combustion chamber. The fuel consumption optimization system includes a control unit configured to operate the power unit in a first measurement phase including activation of the first combustion chamber and deactivation of the second combustion chamber and a second measurement phase including deactivation of the first combustion chamber and activation of the second combustion chamber. The fuel consumption optimization system includes a measurement unit configured to determine a first measurement corresponding to one or more of a torque output and a fuel consumption of the first combustion chamber in the first measurement phase and a second measurement corresponding to one or more of a torque output and a fuel consumption of the second combustion chamber in the second measurement phase. The control unit is configured to operate the power unit in an optimization phase including operation of one or more of the first combustion chamber in correlation with one or more of the first measurement and the second measurement and the second combustion chamber in correlation with one or more of the first measurement and the second measurement.

According to aspects of the disclosure, the control unit may be configured to operate the power unit in the first measurement phase at a first time and the second measurement phase at a second time.

According to aspects of the disclosure, the first time and the second time may be successive.

According to aspects of the disclosure, the control unit may be configured to operate the power unit in at least a first speed and a second speed during each of the first measurement phase and the second measurement phase.

According to aspects of the disclosure, the measurement unit may be configured to determine the first measurement as a ratio of one or more of the torque output and the fuel consumption of the first combustion chamber in relation to at least the first speed and the second speed of the power unit and the second measurement as a ratio of one or more of the torque output and the fuel consumption of the second combustion chamber in relation to at least the first speed and the second speed of the power unit.

According to aspects of the disclosure, the control unit may be configured to increase fuel delivered to the first combustion chamber to activate the first combustion chamber and to increase fuel delivered to the second combustion chamber to activate the second combustion chamber.

According to aspects of the disclosure, the control unit may be configured to decrease fuel delivered to the first combustion chamber to deactivate the first combustion chamber and to decrease fuel delivered to the second combustion chamber to deactivate the second combustion chamber.

According to aspects of the disclosure, the control unit may be configured to operate the power unit in the first measurement phase and the second measurement phase when a power demand of the vehicle is met.

According to aspects of the disclosure, the control unit may be configured to one or more of increase or maintain an amount of fuel delivered to the first combustion chamber when the first measurement is greater than or equal to a predetermined efficiency threshold and decrease or maintain an amount of fuel delivered to the first combustion chamber when the first measurement is less than or equal to the predetermined efficiency threshold.

According to aspects of the disclosure, the control unit may be configured to one or more of increase or maintain an amount of fuel delivered to the second combustion chamber when the second measurement is greater than or equal to a predetermined efficiency threshold and decrease or maintain an amount of fuel delivered to the second combustion chamber when the second measurement is less than or equal to the predetermined efficiency threshold.

According to aspects of the disclosure, a vehicle including the fuel consumption optimization system according to any aspect of the disclosure herein is provided. The vehicle includes a power unit including at least a first combustion chamber and a second combustion chamber, an energy storage unit configured to store electrical energy, and an electric motor configured to convert electrical energy into mechanical energy to propel the vehicle.

According to aspects of the disclosure, the vehicle may include an electric generator configured to cooperate with the power unit to convert mechanical energy generated by the power unit to electrical energy.

According to aspects of the disclosure, the electric generator may be configured to direct the electrical energy to one or more of the energy storage unit and the electric motor.

According to aspects of the disclosure, a method for optimizing fuel consumption of a vehicle is provided. The vehicle includes a power unit including at least a first combustion chamber and a second combustion chamber. The method includes operating the power unit in a first measurement phase including activating the first combustion chamber and deactivating the second combustion chamber and a second measurement phase including deactivating the first combustion chamber and activating the second combustion chamber. The method includes determining a first measurement corresponding to one or more of a torque output and a fuel consumption of the first combustion chamber in the first measurement phase and a second measurement corresponding to one or more of a torque output and a fuel consumption of the second combustion chamber in the second measurement phase. The method includes operating the power unit in an optimization phase including operating of one or more of the first combustion chamber in correlation with one or more of the first measurement and the second measurement and operation of the second combustion chamber in correlation with one or more of the first measurement and the second measurement.

According to aspects of the disclosure, operating the power unit in the first measurement phase and the second measurement phase may include operating the power unit in the first measurement phase at a first time and the second measurement phase at a second time.

According to aspects of the disclosure, the first time and the second time may be successive.

According to aspects of the disclosure, operating the power unit in the first measurement phase and the second measurement phase may include operating the power unit in at least a first speed and a second speed during each of the first measurement phase and the second measurement phase.

According to aspects of the disclosure, determining the first measurement may include determining the first measurement as a ratio of one or more of the torque output and the fuel consumption of the first combustion chamber in relation to at least the first speed and the second speed of the power unit and determining the second measurement as a ratio of one or more of the torque output and the fuel consumption of the second combustion chamber in relation to at least the first speed and the second speed of the power unit.

According to aspects of the disclosure, activating the first combustion chamber may include increasing fuel delivered to the first combustion chamber and activating the second combustion chamber may include increasing fuel delivered to the second combustion chamber.

According to aspects of the disclosure, deactivating the first combustion chamber may include decreasing fuel delivered to the first combustion chamber and deactivating the second combustion chamber may include decreasing fuel delivered to the second combustion chamber.

According to aspects of the disclosure, operating the power unit in the optimization phase may include one or more of increasing or maintaining an amount of fuel delivered to the first combustion chamber when the first measurement is greater than or equal to a predetermined efficiency threshold and decreasing or maintaining an amount of fuel delivered to the first combustion chamber when the first measurement is less than or equal to the predetermined efficiency threshold.

According to aspects of the disclosure, operating the power unit in the optimization phase may include one or more of increasing or maintaining an amount of fuel delivered to the second combustion chamber when the second measurement is greater than or equal to a predetermined efficiency threshold and decreasing or maintaining an amount of fuel delivered to the second combustion chamber when the second measurement is less than or equal to the predetermined efficiency threshold.

In the manner described and according to aspects illustrated herein, the fuel consumption optimization system, the method for optimizing fuel consumption, and the vehicle are configured to determine an efficiency and/or performance of each combustion chamber of a plurality of combustion chambers included by an internal combustion engine and/or a hybrid internal combustion engine of a vehicle to precisely and dynamically improve fuel consumption of the vehicle, without complex implementation.

The disclosed aspects, examples (including any preferred examples), and/or accompanying claims may be suitably combined with each other as would be apparent to a person having ordinary skill in the art. Additional features and advantages are disclosed in the following description, claims, and drawings, and in part will be readily apparent therefrom to persons skilled in the art and/or recognized by practicing the disclosure as described herein.

### BRIEF DESCRIPTION OF THE DRAWINGS

Aspects of the disclosure will be described with reference to the drawings, where like numerals reflect like elements:

FIG. 1 shows a shows a side perspective view of a vehicle according to aspects of the disclosure;

FIG. 2 shows a schematic view of a fuel consumption optimization system configured for use on the vehicle of FIG. 1 according to aspects of the disclosure;

FIG. 3 shows a side perspective view of an engine block of a power unit of the fuel consumption optimization system of FIG. 2 according to aspects of the disclosure;

FIG. 4 shows a partial side cross-sectional view of a combustion chamber of the power unit of the fuel consumption optimization system of FIG. 2 according to aspects of the disclosure; and

FIG. 5 shows a schematic diagram of the fuel consumption optimization system of FIG. 2 according to aspects of the disclosure.

### DETAILED DESCRIPTION

The detailed description set forth below provides information and examples with sufficient detail to enable those skilled in the art to practice the disclosure.

In the description, like numerals represent like parts. Although the technology disclosed herein is described with reference to specific examples, it should be understood that modifications and changes may be made to these examples without going beyond the general scope as defined by the claims. In particular, individual characteristics of the various examples shown and/or mentioned herein may be combined in additional examples. Consequently, the description and the drawings should be considered in a sense that is illustrative rather than restrictive. The Figures, which are not necessarily to scale, depict illustrative aspects and are not intended to limit the scope of the disclosure. The illustrative aspects depicted are intended only as exemplary.

The term “exemplary” is used in the sense of “example,” rather than “ideal.” While aspects of the disclosure are amenable to various modifications and alternative forms, specifics thereof have been shown by way of example in the drawings and will be described in detail. It should be understood, however, that the intention is not to limit aspects of the disclosure to a particular example described. On the contrary, the intention of this disclosure is to cover all modifications, equivalents, and alternatives falling within the scope of the disclosure.

Various materials, methods of construction, methods of fastening, and the like may be described in the context of disclosed examples. Those skilled in the art will recognize known substitutes for the materials, construction methods, fastening methods, and the like, all of which are contemplated as compatible with the disclosed example and are intended to be encompassed by the appended claims.

As used in this disclosure and the appended claims, the singular forms “a,” “an,” and “the” include plural referents, unless the content clearly dictates otherwise. As used in this disclosure and the appended claims, the term “or” is generally employed in a sense including “and/or,” unless the content clearly dictates otherwise.

Throughout the description, including the claims, the terms "comprising a,” “including a,” and “having a” should be understood as being synonymous with "comprising one or more," “including one or more,” and “having one or more” unless otherwise stated. In addition, any range set forth in the description, including the claims, should be understood as including its end value(s), unless otherwise stated. Specific values for described elements should be understood to be within accepted manufacturing or industry tolerances known to one of skill in the art, and any use of the terms "substantially," "approximately," and “generally” should be understood to mean falling within such accepted tolerances.

When an element or feature is referred to herein as being “on,” “engaged to,” “connected to,” or “coupled to” another element or feature, it may be directly on, engaged, connected, or coupled to the other element or feature, or intervening elements or features may be present. In contrast, when an element or feature is referred to herein as being “directly on,” “directly engaged to,” “directly connected to,” or “directly coupled to” another element or feature, there may be no intervening elements or features present. Other words used to describe the relationship between elements or features should be interpreted in a like manner (e.g., “between” versus “directly between,” “adjacent” versus “directly adjacent,” etc.).

Spatially relative terms, such as “top,” “bottom,” “middle,” “inner,” “outer,” “beneath,” “below,” “lower,” “above,” “upper,” and the like may be used herein for ease of description to describe one element or relationship of a feature to another element(s) or feature(s) as illustrated in the drawings. Spatially relative terms may be intended to encompass different orientations of a device in use or operation in addition to the orientation depicted in the drawings. For example, if the device in the drawings is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although the terms “first,” “second,” “third,” etc. may be used herein to describe various elements, components, regions, layers, sections, and/or parameters, these elements, components, regions, layers, sections, and/or parameters should not be limited by these terms. These terms are only used to distinguish one element, component, region, layer, section, or parameter from another element, component, region, layer, section, or parameter. Thus, a first element, component, region, layer, section, or parameter discussed herein could be termed a second element, component, region, layer, section, or parameter without departing from the teachings of the present disclosure.

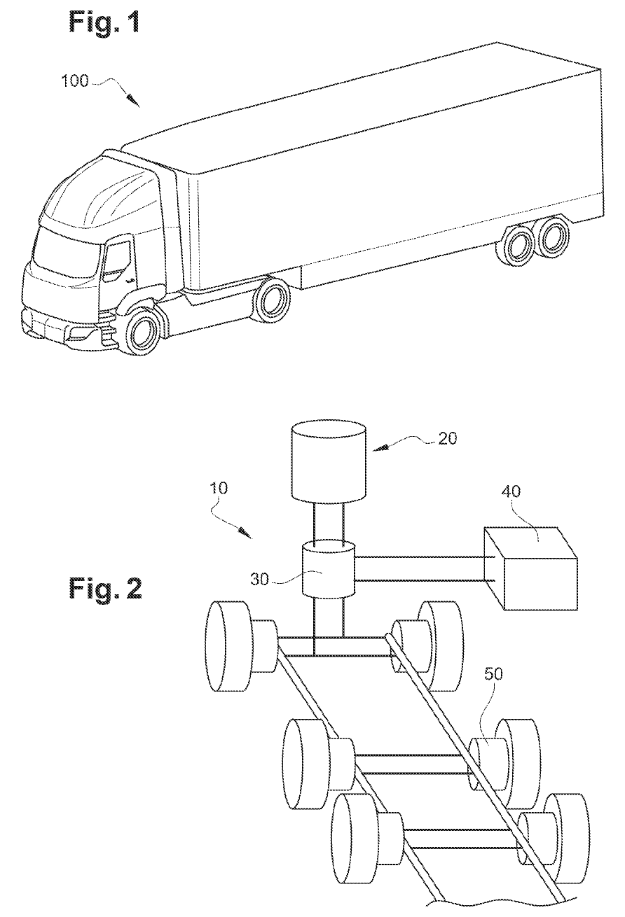

FIGS. 1-2 and 5 show a fuel consumption optimization system 10 (hereafter, referred to as “the system 10”) configured for use on a vehicle 100. Referring to FIG. 1, it is contemplated that the vehicle 100 may be a heavy-duty vehicle, such as a truck, bus, and/or construction equipment. However, it should be understood that the system 10 may be configured for use on other types of vehicles. It is contemplated that the system 10 may be configured for use on an internal combustion engine vehicle. Additionally or alternatively, it is contemplated that the system 10 may be configured for use on a hybrid internal combustion engine-battery electric vehicle and/or a hybrid internal combustion engine-fuel cell electric vehicle. Reference to a hybrid internal combustion engine-battery electric vehicle will be used for purposes of the description, unless reference to an internal combustion engine vehicle, a hybrid internal combustion engine-fuel cell electric vehicle, and/or the like is otherwise necessary.

Referring to FIG. 2, the vehicle 100 to which the system 10 is configured for use on includes a power unit 20. Additionally or alternatively, the power unit 20 may be considered and/or referred to as being included by the system 10. It is contemplated that the power unit 20 may be considered and/or referred to herein as an “internal combustion engine.” In examples, the power unit 20 may be in the form of a hydrogen internal combustion engine configured to utilize hydrogen as a primary source of fuel for combustion. In particular, hydrogen may be utilized as the primary source of fuel in combination with ambient air as an air-fuel mixture for combustion. Additionally or alternatively, the power unit 20 may be in the form of a hydrocarbon internal combustion engine configured to utilize hydrocarbon as a primary source of fuel for combustion. In particular, hydrocarbon may be utilized as the primary source of fuel in combination with ambient air as an air-fuel mixture for combustion. It is contemplated that the vehicle 100 to which the system 10 is configured for use on includes a fuel supply source (not shown) configured to store fuel and to deliver fuel to the power unit 20 (i.e. to one or more combustion chamber 28 included by the power unit 20).

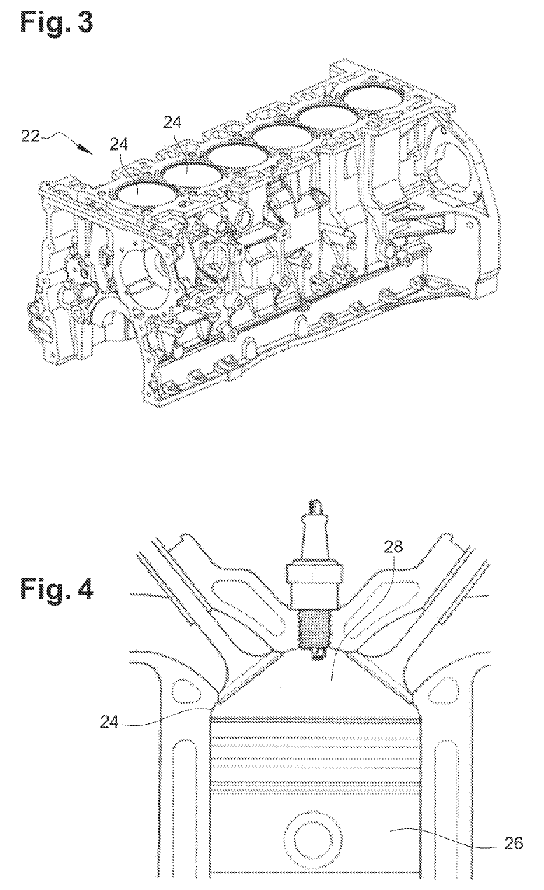

As shown in FIGS. 3-4, the power unit 20 may include an engine block 22 defining one or more cylinder 24. The cylinder 24 is configured to receive a piston 26. Additionally or alternatively, the cylinder 24 is configured for reciprocation of the piston 26 within the cylinder 24. The cylinder 24 and the piston 26 are configured to form a combustion chamber 28. The combustion chamber 28 is configured for combustion of the air-fuel mixture. It is contemplated that combustion of the air-fuel mixture generates mechanical energy. In this manner, the power unit 20 is configured to generate mechanical energy to propel the vehicle 100 and/or to be converted and stored as electrical energy.

In examples, the power unit 20 includes at least a first cylinder 24 and a second cylinder 24. Additionally, the power unit 20 includes at least a first piston 26 and a second piston 26. The first piston 26 is configured to be received by and/or to reciprocate within the first cylinder 24 and the second piston 26 is configured to be received by and/or to reciprocate within the second cylinder 24. The first cylinder 24 and the first piston 26 are configured to form a first combustion chamber 28. The second cylinder 24 and the second piston 26 are configured to form a second combustion chamber 28.

In examples, the power unit 20 may include a plurality of cylinders 24 and a plurality of pistons 26 beyond the first cylinder 24 and the second cylinder 24 and the first piston 26 and the second piston 26. The plurality of cylinders 24 and the plurality of pistons 26 may be configured to form a plurality of combustion chambers 28 beyond the first combustion chamber 28 and the second combustion chamber 28 (e.g. four combustion chambers 28, six combustion chambers 28, eight combustion chambers 28, ten combustion chambers 28, or twelve combustion chambers 28) in the same manner that the first combustion chamber 28 and the second combustion chamber 28 are formed. However, the plurality of combustion chambers 28 will be discussed herein with reference to the first combustion chamber 28 and the second combustion chamber 28, unless reference to the plurality of combustion chambers 28 is otherwise necessary. It should be understood that the structures and/or relationships discussed herein corresponding to the first combustion chamber 28 and the second combustion chamber 28 may be applied to the plurality of combustion chambers 28.

Referring to FIG. 2, the power unit 20 may be configured to cooperate and/or couple with an electric generator 30. It is contemplated that the electric generator 30 may be considered and/or referred to herein as being included by the vehicle 100. Additionally or alternatively, the electric generator 30 may be considered and/or referred to herein as being included by the system 10. The electric generator 30 may be configured to convert mechanical energy generated by the power unit 20 into electrical energy. The electric generator 30 may be configured to direct the electrical energy to one or more of an energy storage unit 40 and an electric motor 50. As such, the vehicle 100 may include one or more of an energy storage unit 40 configured to store electrical energy and an electric motor 50 configured to propel the vehicle 100. Additionally or alternatively, it is contemplated that one or more of the energy storage unit 40 and the electric motor may be considered and/or referred to herein as being included by the system 10.

Referring to FIG. 2, the vehicle 100 may include the energy storage unit 40 (may also be referred to herein as an “ESU 40,” an “energy storage system 40,” and/or an “ESS 40”). Additionally or alternatively, it is contemplated that the ESU 40 may be included by the system 10. The ESU 40 may include one or more battery pack assembly (not shown) configured to store electrical energy. The ESU 40 may be configured to store the electrical energy generated by the power unit 20. As such, it is contemplated that the ESU 40 may be considered and/or referred to herein as being rechargeable. The ESU 40 may be configured to deliver the electrical energy to the electric motor 50 to drive the electric motor 50 and, thus, to propel the vehicle 100.

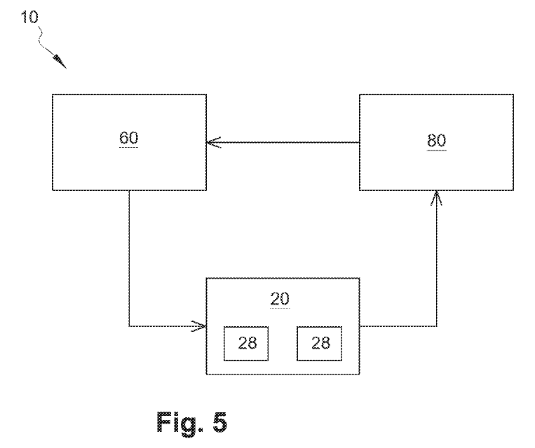

As shown in FIG. 5, it is contemplated that the system 10 includes an electronic control unit 60 (may also be referred to herein as an “ECU 60” and/or a “control unit 60”) configured to operate the power unit 20 and, thus, the system 10. Additionally or alternatively, the ECU 60 may be considered to be included by and/or configured for operation of aspects of the vehicle 100.

In examples, the ECU 60 is configured to operate the power unit 20 in at least a first measurement phase to measure, calculate, and/or determine an efficiency of the first combustion chamber 28 and a second measurement phase to measure, calculate, and/or determine an efficiency of the second combustion chamber 28. In the first measurement phase, the ECU 60 is configured to activate operation of the first combustion chamber 28 and to deactivate operation of the second combustion chamber 28. In the second measurement phase, the ECU 60 is configured to deactivate operation of the first combustion chamber 28 and to activate operation of the second combustion chamber 28. In examples, the ECU 60 may be configured to operate the ECU 60 in the first measurement phase and the second measurement phase when a power demand of the vehicle 100 is met. It is contemplated that the power demand of the vehicle 100 is met during one or more of a braking operation of the vehicle 100 (i.e. during application of brakes of the vehicle 100) and a parking operation of the vehicle 100 (i.e. during parking of the vehicle 100 and/or when the vehicle 100 is placed in a parked position).

In examples, the ECU 60 may be configured to increase fuel delivered to the first combustion chamber 28 to activate the first combustion chamber 28 and the ECU 60 may be configured to decrease fuel delivered to the first combustion chamber 28 to deactivate the first combustion chamber 28. The ECU 60 may be configured to increase fuel delivered to the second combustion chamber 28 to activate the second combustion chamber 28 and the ECU 60 may be configured to decrease fuel delivered to the second combustion chamber 28 to deactivate the second combustion chamber 28. Accordingly, during activation of the first combustion chamber 28 and/or the second combustion chamber 28, the first combustion chamber 28 and/or the second combustion chamber 28 consumes fuel delivered from the fuel supply source of the vehicle 100. Additionally or alternatively, during activation of the first combustion chamber 28 and/or the second combustion chamber 28, the first combustion chamber 28 and/or the second combustion generate a torque output (i.e. mechanical energy) that is converted to electrical energy by the electric generator 30 and/or used to propel the vehicle 100.

In examples, the ECU 60 may be configured to operate the power unit 20 in the first measurement phase at a first time and the second measurement phase at a second time. The first time and the second time of operation of the power unit 20 may be successive and/or alternating, such that the first time occurs before the second time, the second time occurs after the first time, the first time occurs after the second time, and/or the second time occurs before the first time. In this manner, the ECU 60 is configured to operate the first combustion chamber 28 and the second combustion chamber 28 and, thus, the power unit 20, such that the first combustion chamber 28 is operated alone and/or individually, without operation of the second combustion chamber 28. Additionally or alternatively, the ECU 60 is configured to operate the first combustion chamber 28 and the second combustion chamber 28 and, thus, the power unit 20, such that that the second combustion chamber 28 is operated alone and/or individually, without operation of the first combustion chamber 28. Accordingly, in examples in which the power unit 20 includes the plurality of combustion chambers 28 beyond the first combustion chamber 28 and the second combustion chamber 28, the ECU 60 may be configured to operate each combustion chamber 28 of the plurality of combustion chambers 28 alone and/or individually, without operation of the remaining combustion chambers 28 of the plurality of combustion chambers 28. In this manner, the system 10 is configured to measure the efficiency of each combustion chamber 28 of the plurality of combustion chambers 28 alone and/or individually, thereby allowing for more precise and dynamic measurements of the efficiency of the power unit 20.

The ECU 60 may be configured to operate the power unit 20 in at least a first speed and a second speed during each of the first measurement phase and the second measurement phase. The second speed of operation of the power unit 20 may be different from and/or greater than the first speed of operation of the power unit 20. Additionally or alternatively, the second speed of operation of the power unit 20 may be different from and/or less than the first speed of operation of the power unit 20. In examples, the ECU 60 may be configured to operate the power unit 20 in a plurality of speeds beyond the first speed and the second speed during each of the first measurement phase and the second measurement phase. In this manner, the system 10 is configured to make a more accurate, dynamic, and/or wider ranging measurement of the efficiency of the first combustion chamber 28 and the second combustion chamber 28 and, thus, the power unit 20.

As shown in FIG. 5, the system 10 includes a measurement unit 80 configured to measure, calculate, and/or determine (hereafter, “determine”) the efficiency of the first combustion chamber 28 and the second combustion chamber 28. The measurement unit 80 may be configured to determine the efficiency of the first combustion chamber 28 during the first measurement phase and to determine the efficiency of the second combustion chamber 28 during the second measurement phase. In examples, the ECU may include and/or be configured to function as the measurement unit 80. Additionally or alternatively, one or more of the electric generator 30 and the electric motor 50 may include and/or be configured to function as the measurement unit 80.

The measurement unit 80 is configured to determine a first measurement corresponding to the efficiency of the first combustion chamber 28 (may also be referred to herein as a “first efficiency map”) and a second measurement corresponding to the efficiency of the second combustion chamber 28 (may also be referred to herein as a “second efficiency map”). In examples, the first measurement may correspond to one or more of the torque output and fuel consumption of the first combustion chamber 28 and the second measurement may correspond to one or more of the torque output and fuel consumption of the second combustion chamber 28. In examples, the first measurement may be determined as a ratio of one or more of the torque output and the fuel consumption of the first combustion chamber 28 in relation to at least the first speed and the second speed of the power unit 20. The second measurement may be determined as a ratio of one or more of the torque output and the fuel consumption of the second combustion chamber 28 in relation to at least the first speed and the second speed of the power unit 20. It is contemplated that data corresponding to the torque output and fuel consumption of the first combustion chamber 28 and the second combustion chamber 28 may be detected and transmitted to the measurement unit 80 by one or more sensor (not shown) included by the vehicle 100. Additionally or alternatively, it is contemplated that the one or more sensor may be included by the system 10. It is contemplated that the measurement unit 80 may utilize historical data, an algorithm, and/or machine learning to determine the first measurement and the second measurement.

The ECU 60 is configured to operate the power unit 20 in an optimization phase to reduce excess fuel consumption and/or to optimize fuel consumption by the power unit 20. In the optimization phase, the ECU 60 may be configured to operate the first combustion chamber 28 in correlation with one or more of the first measurement and the second measurement. Additionally or alternatively, in the optimization phase, the ECU 60 may be configured to operate the second combustion chamber 28 in correlation with one or more of the first measurement and the second measurement. Accordingly, the ECU 60 may be configured to operate each combustion chamber 28 of the plurality of combustion chambers 28 in correlation with one or more of a measurement corresponding to the corresponding combustion chamber 28 of the plurality of combustion chambers 28 and measurements corresponding to the remaining combustion chambers 28 of the plurality of combustion chambers 28.

In the optimization phase, it is contemplated that the ECU 60 may be configured to increase or maintain an amount of fuel delivered to the first combustion chamber 28 when the first measurement is greater than or equal to a predetermined efficiency threshold and to decrease or maintain an amount of fuel delivered to the first combustion chamber 28 when the first measurement is less than or equal to the predetermined efficiency threshold. Additionally or alternatively, the ECU 60 may be configured to increase or maintain an amount of fuel delivered to the second combustion chamber 28 when the second measurement is greater than or equal to a predetermined efficiency threshold and to decrease or maintain an amount of fuel delivered to the second combustion chamber 28 when the second measurement is less than or equal to the predetermined efficiency threshold. It is contemplated that the predetermined efficiency threshold is the same for each of the first combustion chamber 28 and the second combustion chamber 28. In examples, the predetermined efficiency threshold corresponds to a desired and/or preset value corresponding to one or more of the torque output and the fuel consumption of the first combustion chamber 28 and the second combustion chamber 28. It is contemplated that the predetermined efficiency threshold may be set by one or more of a user of the system 10 and the ECU 60.

Referring to FIG. 5, in operation, the ECU 60 operates the power unit 20 in the first measurement phase at the first time. The measurement unit 80 determines the first measurement corresponding to the first combustion chamber 28. Subsequently, the ECU 60 operates the power unit 20 in the second measurement phase at the second time. The measurement unit 80 determines the second measurement corresponding to the second combustion chamber 28. The ECU 60 operates the first combustion chamber 28 and the second combustion chamber 28 in the optimization phase. Accordingly, the ECU 60 may be configured to operate the power unit 20 in a measurement phase corresponding to each combustion chamber 28 of the plurality of combustion chambers 28 at a time corresponding to each measurement phase of each combustion chamber 28 of the plurality of combustion chambers 28. The measurement unit 80 determines a measurement corresponding to each combustion chamber 28 of the plurality of combustion chambers 28. The ECU 60 operates each combustion chamber 28 of the plurality of combustion chambers 28 in the optimization phase.

In this manner, the system 10 is configured determine an efficiency and/or performance of each combustion chamber 28 of the plurality of combustion chambers 28 included by the power unit 20 of the vehicle 100 to precisely and dynamically improve fuel consumption of the power unit 20 and, thus, the vehicle 100. Additionally, as the system 10 makes use of structures and/or relationships that may be included by the vehicle 100 to precisely and dynamically improve fuel consumption of the power unit 20, the system 10 employs a simplified implementation.

According to examples of the system 10, the system 10 may be provided as follows:

Example 1: A fuel consumption optimization system 10 configured for use on a vehicle 100, the vehicle 100 including a power unit 20 including at least a first combustion chamber 28 and a second combustion chamber 28, the fuel consumption optimization system 10 including: a control unit 60 configured to operate the power unit 20 in a first measurement phase including activation of the first combustion chamber 28 and deactivation of the second combustion chamber 28 and a second measurement phase including deactivation of the first combustion chamber 28 and activation of the second combustion chamber 28; a measurement unit 80 configured to determine a first measurement corresponding to one or more of a torque output and a fuel consumption of the first combustion chamber 28 in the first measurement phase and a second measurement corresponding to one or more of a torque output and a fuel consumption of the second combustion chamber 28 in the second measurement phase; and wherein the control unit 60 is configured to operate the power unit 20 in an optimization phase including operation of one or more of the first combustion chamber 28 in correlation with one or more of the first measurement and the second measurement and the second combustion chamber 28 in correlation with one or more of the first measurement and the second measurement.

Example 2: The fuel consumption optimization system 10 according to Example 1, wherein the control unit 60 is configured to operate the power unit 20 in the first measurement phase at a first time and the second measurement phase at a second time.

Example 3: The fuel consumption optimization system 10 according to Example 2, wherein the first time and the second time are successive.

Example 4: The fuel consumption optimization system 10 according to any of Examples 1-3, wherein the control unit 60 is configured to operate the power unit 20 in at least a first speed and a second speed during each of the first measurement phase and the second measurement phase.

Example 5: The fuel consumption optimization system 10 according to Example 4, wherein the measurement unit 80 is configured to determine the first measurement as a ratio of one or more of the torque output and the fuel consumption of the first combustion chamber 28 in relation to at least the first speed and the second speed of the power unit 20 and the second measurement as a ratio of one or more of the torque output and the fuel consumption of the second combustion chamber 28 in relation to at least the first speed and the second speed of the power unit 20.

Example 6: The fuel consumption optimization system 10 according to any of Examples 1-5, wherein the control unit 60 is configured to increase fuel delivered to the first combustion chamber 28 to activate the first combustion chamber 28 and to increase fuel delivered to the second combustion chamber 28 to activate the second combustion chamber 28.

Example 7: The fuel consumption optimization system 10 according to any of Examples 1-6, wherein the control unit 60 is configured to decrease fuel delivered to the first combustion chamber 28 to deactivate the first combustion chamber 28 and to decrease fuel delivered to the second combustion chamber 28 to deactivate the second combustion chamber 28.

Example 8: The fuel consumption optimization system 10 according to any of Examples 1-7, wherein the control unit 60 is configured to operate the power unit 20 in the first measurement phase and the second measurement phase when a power demand of the vehicle 100 is met.

Example 9: The fuel consumption optimization system 10 according to any of Examples 1-8, wherein the control unit 60 is configured to one or more of increase or maintain an amount of fuel delivered to the first combustion chamber 28 when the first measurement is greater than or equal to a predetermined efficiency threshold and decrease or maintain an amount of fuel delivered to the first combustion chamber 28 when the first measurement is less than or equal to the predetermined efficiency threshold.

Example 10: The fuel consumption optimization system 10 according to any of Examples 1-9, wherein the control unit 60 is configured to one or more of increase or maintain an amount of fuel delivered to the second combustion chamber 28 when the second measurement is greater than or equal to a predetermined efficiency threshold and decrease or maintain an amount of fuel delivered to the second combustion chamber 28 when the second measurement is less than or equal to the predetermined efficiency threshold.

Example 11: A vehicle 100 including the fuel consumption optimization system 10 according to any of Examples 1-10, the vehicle 100 including: a power unit 20 including at least a first combustion chamber 28 and a second combustion chamber 28; an energy storage unit 40 configured to store electrical energy; and an electric motor 50 configured to convert electrical energy into mechanical energy to propel the vehicle.

Example 12: The vehicle 100 according to Example 11, including an electric generator 30 configured to cooperate with the power unit 20 to convert mechanical energy generated by the power unit 20 to electrical energy.

Example 13: The vehicle 100 according to Example 12, wherein the electric generator 30 is configured to direct the electrical energy to one or more of the energy storage unit 40 and the electric motor 50.

Example 14: A method for optimizing fuel consumption of a vehicle 100, the vehicle including a power unit 20 including at least a first combustion chamber 28 and a second combustion chamber 28, the method including: operating the power unit 20 in a first measurement phase including activating the first combustion chamber 28 and deactivating the second combustion chamber 28 and a second measurement phase including deactivating the first combustion chamber 28 and activating the second combustion chamber 28; determining a first measurement corresponding to one or more of a torque output and a fuel consumption of the first combustion chamber 28 in the first measurement phase and a second measurement corresponding to one or more of a torque output and a fuel consumption of the second combustion chamber 28 in the second measurement phase; and operating the power unit 20 in an optimization phase including operating of one or more of the first combustion chamber 28 in correlation with one or more of the first measurement and the second measurement and operation of the second combustion chamber 28 in correlation with one or more of the first measurement and the second measurement.

Example 15: The method according to Example 14, wherein operating the power unit 20 in the first measurement phase and the second measurement phase includes operating the power unit 20 in the first measurement phase at a first time and the second measurement phase at a second time.

Example 16: The method according to Example 15, wherein the first time and the second time are successive.

Example 17: The method according to any of Examples 14-16, wherein operating the power unit 20 in the first measurement phase and the second measurement phase includes operating the power unit 20 in at least a first speed and a second speed during each of the first measurement phase and the second measurement phase.

Example 18: The method according to Example 17, wherein determining the first measurement includes determining the first measurement as a ratio of one or more of the torque output and the fuel consumption of the first combustion chamber 28 in relation to at least the first speed and the second speed of the power unit 20 and determining the second measurement as a ratio of one or more of the torque output and the fuel consumption of the second combustion chamber 28 in relation to at least the first speed and the second speed of the power unit 20.

Example 19: The method according to any of Examples 14-18, wherein activating the first combustion chamber 28 includes increasing fuel delivered to the first combustion chamber 28 and activating the second combustion chamber 28 includes increasing fuel delivered to the second combustion chamber 28.

Example 20: The method according to any of Examples 14-19, wherein deactivating the first combustion chamber 28 includes decreasing fuel delivered to the first combustion chamber 28 and deactivating the second combustion chamber 28 includes decreasing fuel delivered to the second combustion chamber 28.

Example 21: The method according to any of Examples 14-20, wherein operating the power unit 20 in the optimization phase includes one or more of increasing or maintaining an amount of fuel delivered to the first combustion chamber 28 when the first measurement is greater than or equal to a predetermined efficiency threshold and decreasing or maintaining an amount of fuel delivered to the first combustion chamber 28 when the first measurement is less than or equal to the predetermined efficiency threshold.

Example 22: The method according to any of Examples 14-21, wherein operating the power unit 20 in the optimization phase includes one or more of increasing or maintaining an amount of fuel delivered to the second combustion chamber 28 when the second measurement is greater than or equal to a predetermined efficiency threshold and decreasing or maintaining an amount of fuel delivered to the second combustion chamber 28 when the second measurement is less than or equal to the predetermined efficiency threshold.

Although the present disclosure herein has been described with reference to particular examples, it is to be understood that these examples are merely illustrative of the principles and applications of the present disclosure.

It is intended that the specification and examples be considered as exemplary only, with a true scope of the disclosure being indicated by the following claims.

Additionally, all of the disclosed features of an apparatus may be transposed, alone or in combination, to a method and vice versa.

What is claimed is:

1. A fuel consumption optimization system configured for use on a vehicle, the vehicle comprising a power unit including at least a first combustion chamber and a second combustion chamber, the fuel consumption optimization system comprising:
a control unit configured to operate the power unit in a first measurement phase including activation of the first combustion chamber and deactivation of the second combustion chamber and a second measurement phase including deactivation of the first combustion chamber and activation of the second combustion chamber;
a measurement unit configured to determine a first measurement corresponding to one or more of a torque output and a fuel consumption of the first combustion chamber in the first measurement phase and a second measurement corresponding to one or more of a torque output and a fuel consumption of the second combustion chamber in the second measurement phase; and
wherein the control unit is configured to operate the power unit in an optimization phase including operation of one or more of the first combustion chamber in correlation with one or more of the first measurement and the second measurement and the second combustion chamber in correlation with one or more of the first measurement and the second measurement.

2. The fuel consumption optimization system of claim 1, wherein the control unit is configured to operate the power unit in the first measurement phase at a first time and the second measurement phase at a second time.

3. The fuel consumption optimization system of claim 2, wherein the first time and the second time are successive.

4. The fuel consumption optimization system of claim 1, wherein the control unit is configured to operate the power unit in at least a first speed and a second speed during each of the first measurement phase and the second measurement phase.

5. The fuel consumption optimization system of claim 4, wherein the measurement unit is configured to determine the first measurement as a ratio of one or more of the torque output and the fuel consumption of the first combustion chamber in relation to at least the first speed and the second speed of the power unit and the second measurement as a ratio of one or more of the torque output and the fuel consumption of the second combustion chamber in relation to at least the first speed and the second speed of the power unit.

6. The fuel consumption optimization system of claim 1, wherein the control unit is configured to increase fuel delivered to the first combustion chamber to activate the first combustion chamber and to increase fuel delivered to the second combustion chamber to activate the second combustion chamber.

7. The fuel consumption optimization system of claim 1, wherein the control unit is configured to decrease fuel delivered to the first combustion chamber to deactivate the first combustion chamber and to decrease fuel delivered to the second combustion chamber to deactivate the second combustion chamber.

8. The fuel consumption optimization system of claim 1, wherein the control unit is configured to operate the power unit in the first measurement phase and the second measurement phase when a power demand of the vehicle is met.

9. The fuel consumption optimization system of claim 1, wherein the control unit is configured to one or more of increase or maintain an amount of fuel delivered to the first combustion chamber when the first measurement is greater than or equal to a predetermined efficiency threshold and decrease or maintain an amount of fuel delivered to the first combustion chamber when the first measurement is less than or equal to the predetermined efficiency threshold.

10. The fuel consumption optimization system of claim 1, wherein the control unit is configured to one or more of increase or maintain an amount of fuel delivered to the second combustion chamber when the second measurement is greater than or equal to a predetermined efficiency threshold and decrease or maintain an amount of fuel delivered to the second combustion chamber when the second measurement is less than or equal to the predetermined efficiency threshold.

11. A vehicle comprising the fuel consumption optimization system of claim 1, the vehicle comprising:
a power unit including at least a first combustion chamber and a second combustion chamber;
an energy storage unit configured to store electrical energy; and
an electric motor configured to convert electrical energy into mechanical energy to propel the vehicle.

12. The vehicle of claim 11, comprising an electric generator configured to cooperate with the power unit to convert mechanical energy generated by the power unit to electrical energy.

13. A method for optimizing fuel consumption of a vehicle, the vehicle comprising a power unit including at least a first combustion chamber and a second combustion chamber, the method comprising:
operating the power unit in a first measurement phase including activating the first combustion chamber and deactivating the second combustion chamber and a second measurement phase including deactivating the first combustion chamber and activating the second combustion chamber;
determining a first measurement corresponding to one or more of a torque output and a fuel consumption of the first combustion chamber in the first measurement phase and a second measurement corresponding to one or more of a torque output and a fuel consumption of the second combustion chamber in the second measurement phase; and
operating the power unit in an optimization phase including operating of one or more of the first combustion chamber in correlation with one or more of the first measurement and the second measurement and operation of the second combustion chamber in correlation with one or more of the first measurement and the second measurement.

14. The method of claim 13, wherein operating the power unit in the optimization phase includes one or more of increasing or maintaining an amount of fuel delivered to the first combustion chamber when the first measurement is greater than or equal to a predetermined efficiency threshold and decreasing or maintaining an amount of fuel delivered to the first combustion chamber when the first measurement is less than or equal to the predetermined efficiency threshold.

15. The method of claim 13, wherein operating the power unit in the optimization phase includes one or more of increasing or maintaining an amount of fuel delivered to the second combustion chamber when the second measurement is greater than or equal to a predetermined efficiency threshold and decreasing or maintaining an amount of fuel delivered to the second combustion chamber when the second measurement is less than or equal to the predetermined efficiency threshold.
